(19) United States
(12) Patent Application Publication
(10) Pub. No.: US 2014/0086571 A1
(43) Pub. Date: Mar. 27, 2014

(54) PASSIVE OPTICAL NETWORK WITH IMMEDIATE FAULT PROTECTION AND METHOD FOR PROTECTING SERVICES OF THE SAME

(71) Applicant: Telekom Malaysia Berhad, Kuala Lumpur (MY)

(72) Inventors: Kok Hann Fong, Medan Damansara (MY); Chun Yeow Yeoh, Petaling Jaya (MY); Zulkalnain bin Mohd Yusoff, Puchong (MY); Zulhedry Abdul Manaf, Bandar Baru Bangi (MY)

(73) Assignee: Telekom Malaysia Berhad, Kuala Lumpur (MY)

(21) Appl. No.: 14/038,869

(22) Filed: Sep. 27, 2013

(30) Foreign Application Priority Data
Sep. 27, 2012 (MY) PI2012004286

(51) Int. Cl. H04B 10/032

(52) U.S. Cl. CPC H04B 10/032
USPC 398/2

(57) ABSTRACT

A passive optical network (100) with immediate fault protection comprises an optical line termination (OLT) (11), an optical distribution network communicating with the OLT (11), the optical distribution network comprising a splitter (13) connected to the OLT (11) through a feed fiber (15) for separating and distributing optical signals from the OLT (11), a plurality of optical network units (ONUs) (17) each connected to the splitter (13) through a distribution fiber (19), and characterized in that each ONU (17) is equipped with a wireless router (21) communicating with its adjacent wireless routers (21) to form a mesh-like wireless network, whereby when failure has occurred in any distribution fiber (19) connected to the ONUs (17), the wireless router (21) of the disabled ONU (17) connected to the fiber (19) automatically searches and receives bandwidth from the nearest wireless router (21) of the ONU (17) connected to the functioning fiber (19) or wireless router (21) of disabled ONU (17) through the mesh-like network to avoid connection failure of the ONU (17) to the OLT (11).

### FIELD OF INVENTION

The present invention relates to a passive optical network with immediate fault protection. More particularly, a passive optical network with immediate fault protection having optical network units provided with wireless routers to form a mesh-like wireless network.

### BACKGROUND OF INVENTION

A passive optical network (PON) is a point-to-multipoint, fiber to the subscribers network architecture in which optical splitters are deployed to serve multiple subscribers by a single optical fiber. A PON comprises an optical line terminal (OLT) at the service provider endpoint and a plurality of optical network units (ONUs) near to end subscribers. A PON reduces the number of fibers and electrically powered switching equipment required as compared with active optical network (AON) and point-to-point network architectures. The passive optical network does not include electrically powered switching equipment and instead uses optical splitters to separate and collect optical signals.

When a fault occurs either on the distribution fiber linking an ONU to an OLT or the ONU itself connected to a subscriber's premise, the subscriber would lose connection to the OLT completely. A typical mitigation method of above fault is by providing an additional fiber linking from another OLT to each ONU as shown in FIG. 1. However, this method requires the installation of an additional fiber for each subscriber which increases costs and increases complexity of managing the overall fibers.

Another example of the conventional mitigation method of above fault is U.S. Pat. No. 7,831, 145 to Hua Wei Technologies Co., Ltd. which discloses a passive optical network (PON) system and a method for protecting the service of the system for service recovery and fault locating in case of failure of the network. An optical network unit (ONU) comprising a service port configured to communicate with an Optical Line Terminal (OLT), wherein the service port is configured to support a first bandwidth assigned to the ONU figured to support a first bandwidth assigned to the ONU and a second bandwidth assigned to a second ONU. A backup port configured to communicate with the second ONU. and a switching module in communication with the service port and the backup port. The switching module is configured to transfer services when a failure has not occurred and the service port receives the sum of the first bandwidth and the second bandwidth when the failure occurs. However, it is rather difficult to backup the service if failure has occurred at the same time to both the adjacent ONUs which periodically check each other's states via the backup link.

Accordingly, it is desirable to provide a passive optical network with immediate fault protection having optical network units (ONUs) provided with wireless routers to form a mesh-like wireless network which capable to backup disabled ONU or ONUs which adjacent or not adjacent with the ONU connected to functioning fiber.

### SUMMARY OF INVENTION

This invention hence aims to provide a passive optical network with immediate fault protection through a mesh-like wireless network to avoid service interruption.

This invention relates to a passive optical network with immediate fault protection comprises an optical line termination (OLT), an optical distribution network communicating with the OLT, the optical distribution network comprising a splitter connected to the OLT through a feed fiber for separating and distributing optical signals from the OLT, a plurality of optical network units (ONUs) each connected to the splitter through a distribution fiber, and characterized in that each ONU is equipped with a wireless router communicating with its adjacent wireless routers to form a mesh-like wireless network, whereby when failure has occurred in any distribution fiber connected to the ONUs, the wireless router of the disabled ONU connected to the failed fiber automatically searches and receives bandwidth from the nearest wireless router of ONU connected to the functioning fiber or wireless router of disabled ONU through the mesh-like network to avoid connection failure of the ONU to the OLT. The traffic hops from one wireless router to another wireless router until reaching one of the wireless routers with ONU connected to the functioning fiber so that the recovery process can happen. Using multi-hop communication, even with adjacent wireless router's ONU failed, the service can be resumed as long as mesh-like network is formed.

Preferably, the wireless router has a virtual access point (VAP) with secured Service Set Identifier (SSID).

Preferably, the SSID can be capped at specific data rate to avoid bandwidth taken up by the disabled ONU from the ONU connected to the functioning fiber.

Preferably, a protocol is provided in the OLT to immediately increase the available bandwidth for the ONU connected to the functioning fiber which provides bandwidth to the disabled ONU.

Preferably, the wireless router is programmed such that to automatically conduct channel scanning and selection to neighbouring wireless routers once the failure has occurred to the distribution fiber connected to the disabled ONU.

Preferably, the passive optical network further comprising an additional OLT communicates with the optical distribution network to continually provide the optical signal to the optical distribution network when the initial OLT fails.

Preferably, the present invention provides a method of immediately protecting service of a passive optical network comprising the steps of detecting failure of any distribution fiber connected to the ONUs, initiating the wireless router of the disabled ONU connected to the disabled fiber connected to the failed fiber to search for bandwidth from the nearest wireless router of the ONU connected to the functioning fiber or wireless router of the disabled ONU through the mesh-like network, bridging the wireless router of the disabled ONU to the wireless router of the ONU connected to the functioning fiber through its virtual access point (VAP) with secured Service Set Identifier (SSID), and sending bandwidth from the wireless router of the ONU connected to the functioning fiber to the wireless router of the disabled ONU to avoid connection failure of the ONU to the OLT.

Other objects and advantages will be more fully apparent from the following disclosure and appended claims.

### BRIEF DESCRIPTION OF DRAWINGS

FIG. 1 shows a schematic drawing illustrating a conventional passive optical network with backup distribution fibers and optical line terminal (OLT);

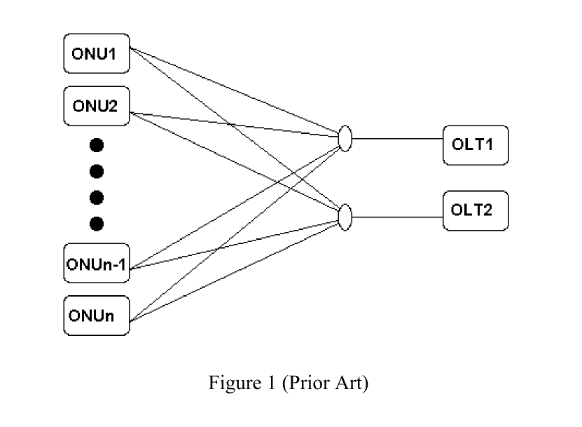

FIG. 2 shows a schematic drawing illustrating a passive optical network with immediate fault protection in a first preferred embodiment of the present invention;

FIG. 3 shows a schematic drawing illustrating a passive optical network with immediate fault protection in a second preferred embodiment of the present invention;

FIG. 4 shows a schematic drawing illustrating a passive optical network with immediate fault protection in a second preferred embodiment of the present invention; and

FIG. 5 shows a flowchart illustrating a method of immediately protecting service of a passive optical network when fault occurred in a preferred embodiment of the present invention.

### DETAILED DESCRIPTION OF INVENTION

The present invention is described as a large extent of specification in terms of passive optical network with immediate fault protection and method for protecting services of the same. The features and advantages of this invention may be realized and obtained by the means of the instruments and combinations particularly pointed out in the appended claims. These and other features of the present invention will become more apparent from the following description and appended claims, or may be learned by the practice of the invention as set forth herein.

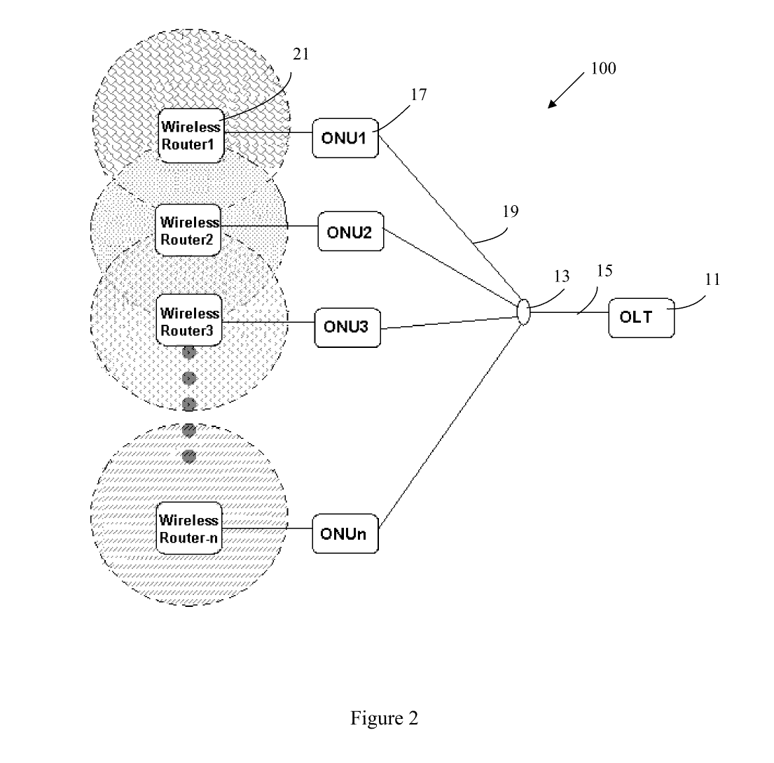

Various embodiments of the invention are discussed in detail below. Exemplary method and apparatus for immediately protecting services of a passive optical network (100) are now explained with reference to the drawings, starting with FIG. 2. FIG. 2 illustrates a first embodiment of a passive optical network (100) with immediate fault protection comprises an optical line termination (OLT) (11) and an optical distribution network communicates with the OLT (11). The optical distribution network comprises a splitter (13) connected to the OLT (11) through a feed fiber (15) for separating and distributing optical signals from the OLT (11), a plurality of optical network units (ONUs) each connected to the splitter (13) through a distribution fiber (19), each ONU (17) is equipped with a wireless router (21), each wireless router (21) communicating with its adjacent wireless routers (21) to form a mesh-like wireless network. When failure has occurred to any distribution fiber (19) connected to the ONUs (17), the wireless router (21) of the disabled ONU (17) connected to the failed fiber automatically searches and receives bandwidth from the nearest wireless router (21) of the ONU (17) connected to the functioning fiber or wireless router (21) of the disabled ONU (17) through the mesh-like network to avoid connection failure of the ONU (17) to the OLT (11).

In most areas, the area of coverage of the wireless router (21) would extend beyond the physical premise of the customer and overlap with the area of neighboring customer. The overlap typically causes interference which is overcome by not using the adjacent channel by the two or more wireless routers (21) of interest. The internal programming of the wireless routers (21) can be programmed such as to conduct channel scanning and selection to neighboring wireless routers (21) to avoid any service interruption once a connection through the normal route is broken. The wireless router (21) has a virtual access point (VAP) with secured Service Set Identifier (SSID). The SSID can be capped at specific data rate to avoid bandwidth of the ONU (17) connected to the functioning fiber taken up by the disabled ONU (17). A protocol is provided in the OLT (11) to immediately increase the available bandwidth for the ONU (17) connected to the functioning fiber which provides bandwidth to the disabled ONU (17).

The current bandwidth available to the subscriber through PON system is typically 5 Mbps to 20 Mbps, the additional load to the neighbor's wireless router (21) would not be overwhelmed as the bandwidth specifications of wireless routers (17) are higher. In fact, based on 802.11n standard, using 2 spatial streams, common chipset that available; it should be 300 Mbps using 40 MHz channel bandwidth and 130 Mbps for 20 MHz bandwidth upwards.

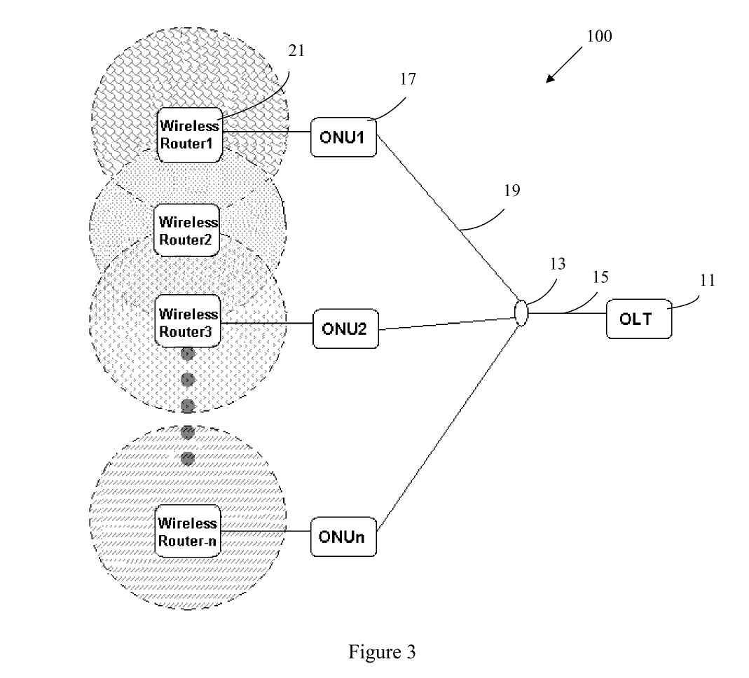

Referring to FIG. 3, there is shown a second embodiment of a passive optical network (100) with immediate fault protection. The passive optical network (100) further comprising an independent wireless router (17) in the mesh-like network for connecting wireless routers (17) which connected to the ONUs (17) where their network coverage are not overlapped. This could provide a wider range of coverage for the mesh-like network for immediate fault protection.

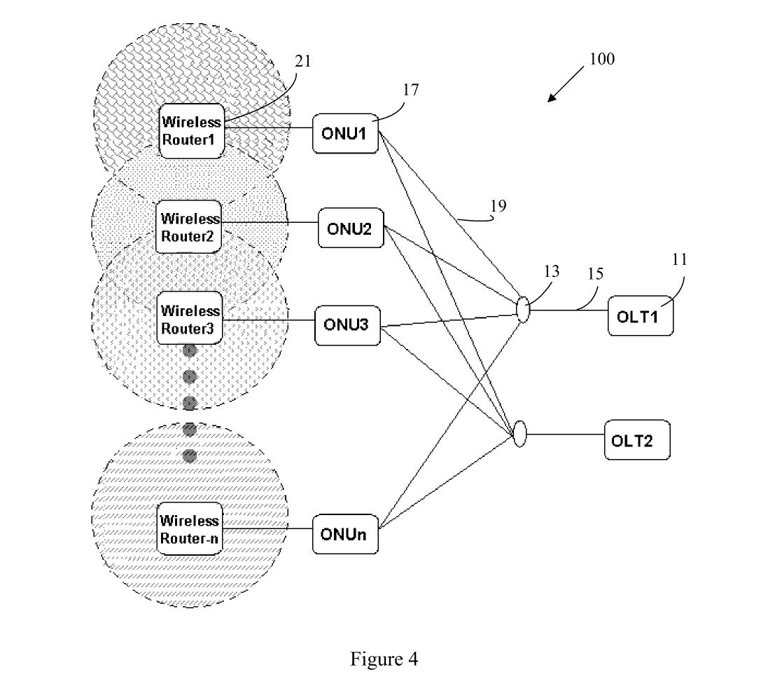

Referring to FIG. 4, there is shown a third embodiment of a passive optical network (100) with immediate fault protection. The passive optical network (100) further comprising an additional OLT (11) communicates with the optical distribution network to continually provide the optical signal to the optical distribution network when the initial OLT (11) fails. This provide an even higher redundancy and protection from failures, the connection to another additional OLT (11) can be interleaved with the existing one thus when one of the connection to an OLT (11) or an OLT (11) fails, the protection mechanism through wireless router (21) can be activated and reroute the traffic through the other additional OLT (11).

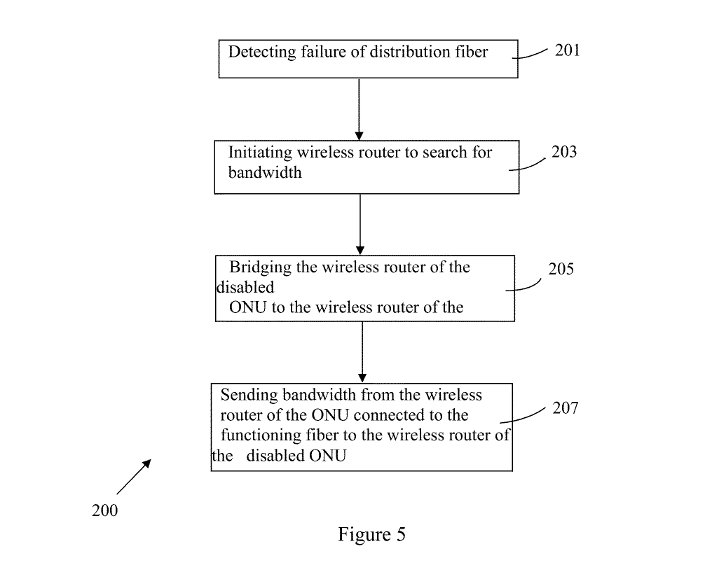

Referring to FIG. 5, there is shown a flowchart illustrating a method (200) of immediately protecting services of a passive optical network (100) when fault occurred. Firstly, failure of any distribution fiber (19) connected to the ONUs (17) is detected (201). The wireless router (21) of the disabled ONU (17) is initiated to search for bandwidth from the nearest wireless router (21) of the ONU (17) connected to the functioning fiber or wireless router of the disabled ONU (17) through the mesh-like network (203). The wireless router (21) of the disabled ONU (17) is then bridged to the wireless router (21) of the ONU (17) connected to the functioning fiber through its virtual access point (VAP) with secured Service Set Identifier (SSID) (205). Bandwidth from the wireless router (21) of the ONU (17) connected to the functioning fiber is sent to the wireless router (21) of the disabled ONU (17) to avoid connection failure of the ONU (17) to the OLT (11) (207). The SSID is capped at specific data rate to avoid bandwidth taken up by the disabled ONU (17) from the ONU (17) connected to the functioning fiber. A protocol is provided in the OLT (11) to immediately increase the available bandwidth for the ONU (17) connected to the functioning fiber which provides bandwidth to the disabled ONU (17).

While several particularly preferred embodiments of the present invention have been described and illustrated, it should now be apparent to those skilled in the art that various changes and modifications can be made without departing from the spirit and scope of the invention. Accordingly, the following claims are intended to embrace such changes, modifications, and areas of application that are within the scope of this invention.

1. A passive optical network (100) with immediate fault protection comprising:
an optical line termination (OLT) (11);
an optical distribution network communicating with the OLT (11), the optical distribution network comprising:
a splitter (13) connected to the OLT (11) through a feed fiber (15) for separating and distributing optical signals from the OLT (11);
a plurality of optical network units (ONUs) (17) each connected to the splitter (13) through a distribution fiber (19); and
characterized in that each ONU (17) is equipped with a wireless router (21) communicating with its adjacent wireless routers (21) to form a mesh-like wireless network,
whereby when failure has occurred in any distribution fiber (19) connected to the ONUs (17), the wireless router (21) of the disabled ONU (17) connected to the failed fiber (19) automatically searches and receives bandwidth from the nearest wireless router (21) of the ONU (17) connected to the functioning fiber (19) or wireless router (21) of the disabled ONU (17) through the mesh-like network to avoid connection failure of the ONU (17) to the OLT (11).

2. A passive optical network (100) according to claim 1, wherein the wireless router (21) has a virtual access point (VAP) with secured Service Set Identifier (SSID).

3. A passive optical network (100) according to claim 2, wherein the SSID can be capped at specific data rate to avoid bandwidth of the ONU (17) connected to the functioning fiber (19) taken up by the disabled ONU (17).

4. A passive optical network (100) according to claim 1, wherein a protocol is provided in the OLT (11) to immediately increase the available bandwidth for the ONU (17) connected to the functioning fiber (19) which provides bandwidth to the disabled ONU (17).

5. A passive optical network (100) according to claim 1, wherein the wireless router (21) is programmed such that to conduct channel scanning and selection to neighboring wireless routers (21) once the failure has occurred to the distribution fiber (19) connected to the ONU (17).

6. A passive optical network (100) according to claim 1, further comprising an additional OLT (11) communicates with the optical distribution network to continually provide the optical signals to the optical distribution network when the initial OLT (11) fails.

7. A passive optical network (100) according to claim 1, further comprising an independent wireless router (21) in the mesh-like network for connecting wireless routers (21) which connected to the ONUs (17) where their network coverage are not overlapped.

8. A method (200) of immediately protecting service of a passive optical network (100) of claim 1 comprising the steps of:
detecting failure of any distribution fiber (19) connected to the ONUs (17) (201);
initiating the wireless router (21) of the disabled ONU (17) to search for bandwidth from the nearest wireless router (21) of the ONU (17) connected to the functioning fiber (19) or wireless router (21) of the disabled ONU (17) through the mesh-like network (203);
bridging the wireless router of the disabled ONU (17) to the wireless router (21) of the ONU (17) connected to the functioning fiber (19) through its virtual access point (VAP) with secured Service Set Identifier (SSID) (205); and
sending bandwidth from the wireless router (21) of the ONU (17) connected to the functioning fiber (19) to the wireless router (21) of the disabled ONU (17) to avoid connection failure of the disabled ONU (17) to the OLT (11) (207).

9. A method (200) according to claim 8, further comprising the step of capping the SSID at specific data rate to avoid bandwidth taken up by the disabled ONU (17) from the ONU (17) connected to the functioning fiber (19).

10. A method (200) according to claim 8, further comprising the step of providing a protocol in the OLT (11) to immediately increase the available bandwidth for the ONU (17) connected to the functioning fiber (19) which provides bandwidth to the disabled ONU (17).

11. A method (200) according to claim 8, wherein the wireless router (21) is programmed such that to conduct channel scanning and selection to neighboring wireless routers (21) once the failure has occurred to the distribution fiber (19) connected to the ONU (17).

12. A method (200) according to claim 8, further comprising an additional OLT (11) communicates with the optical distribution network to continually provide the optical signals to the optical distribution network when the initial OLT (11) fails.

13. A method (200) according to claim 8, further comprising an independent wireless router (21) in the mesh-like network for connecting wireless routers (21) which connected to the ONUs (17) where their network coverages are not overlapped.
